(19) United States
(12) Patent Application Publication
(10) Pub. No.: US 2026/0317517 A1
(43) Pub. Date: Oct. 15, 2026

(54) THERMOPLASTIC STARCH FORMING COMPOSITIONS AND USES THEREOF

(71) Applicant: UMONS - UNIVERSITY OF MONS, Mons (BE)

(72) Inventors: Serena Maria TORCASIO, Messina (IT); Gilles CRAHAY, Ixelles (BE); Jean-Marie RAQUEZ, Mons (BE); Heidi JACOBS, Kruisem (BE)

(21) Appl. No.: 19/101,382

(22) PCT Filed: Aug. 10, 2023
(86) PCT No.: PCT/EP2023/072124

§ 371 Date: Feb. 5, 2025

(30) Foreign Application Priority Data
Aug. 10, 2022 (BE) BE2022/5623

(51) Int. Cl. C08L 3/02; C08J 5/18; C08K 5/053; C08K 5/092

(52) U.S. Cl. CPC C08L 3/02; C08J 5/18; C08K 5/053; C08K 5/092

(57) ABSTRACT

A composition suitable for forming a bioplastic or thermoplastic starch derived from pulse starch, and its use in producing biodegradable films and packaging, particularly cold water-soluble starch-based films for packaging.

### FIELD OF THE INVENTION

The invention is broadly in the field of thermoplastics and bioplastics, more precisely in the field of such derived from starch. In particular, the invention concerns a composition suitable for forming a bioplastic or thermoplastic starch derived from pea starch, and its use in producing (bio)degradable films and packaging. More particular the invention relates to cold water soluble starch based films especially for preparing detergent tablets covers.

### BACKGROUND OF THE INVENTION

Cold water soluble starch based films for packaging of e.g. detergents allow the detergent release in watery environment at a temperature of 20° C. and above. This feature allows the use of lower cleaning temperatures, resulting in less energy consumption for the users and using an environment friendly material.

At the present moment cold water soluble starch blend films are commercially available, and in those formulations, starch is used to substitute a certain percentage of non-biodegradable polymers. In this way the environmental impact is reduced, but problems of compatibility between starch and the other polymers can arise, solubility can decrease in function of the starch percentage component and also some mechanical properties can be lost.

The most important example of such systems are starch blends with polyvinyl alcohol (PVOH). This polymer is biodegradable, but not biosourced/biobased, in fact it is derived by oil refinery processes from fossil fuels. Despite its nature, it has good mechanical properties, elasticity, transparency and solubility and can be considered the gold standard for cold water soluble films.

In order to reduce the environmental impact of PVOH, it is substituted by starch, or starch blends with micro-crystalline hydroxy propyl cellulose and bio-derived swelling polymers such alginate and gums. Those attempts improve the biocompatibility and biodegradability of the film, but the solution in cold water remains around 65% at the best, especially for starch blends with polymers different by PVOH.

Alginate, gums and even starch in its natural form are in fact swelling polymers, that absorb water, increasing the viscosity of the solution. This means they are not naturally dissolving in an aqueous medium. The classical way of increasing the solubility is to increase water temperature under strong agitation, usually close to 60-90° C., depending on the concentration of the solution. However, even with said agitation and heating steps, those solution remain highly viscous. This is a real problem for film application, because even though washing machines and dish washers have good rinsing capabilities, filters and connector tubes can't stand high viscous solutions, with the high risk of tube clogging.

To avoid this problem, starch is often chemically modified through hydroxypropylation, oxidation and functionalization with anhydrides. Starch modification is not simple, because the raw material is a powder, and before to be correctly transformed in films it needs to be transformed in pellets of thermoplastic starch. The most used industrial processes are extrusion, such as reactive extrusion and plastograph mixing. The procedures reported in literature foresee a first mix of starch powder with a plasticizer. A paste is obtained, that needs to swell for a time of between 6 and 24 hours. After this period, the paste is processed in a plastograph, with water and other additives in the desired amount for the desired time. This way thermoplastic starch is obtained, that can be pelleted and extruded into films.

The extrusion processes currently performed in an industrial environment make use of toxic reagents that can be dangerous to the environment and can sometimes destroy the starch structure. As a consequence, although the raw materials to prepare the films are biobased, biocompatible, and biodegradable, the resulting products can contain chemicals residuals, and if starch structure has been highly modified, can be biodegraded less easily.

Summarizing, starch modification processes bear a particularly high environmental cost and present numerous technical constraints.

In order to improve starch processability those skilled in the art combine the raw starch powder with plasticizers. Those are usually polyols, such as sorbitol, mannitol, glycerol, polyethylene glycol, xylitol, and fructose. Among those, glycerol has been chosen because its capability to allow starch swelling, allowing in this way the disruption of granule crystallinity and the transition to an amorph thermoplastic material. Glycerol is also not expensive, non-toxic, biocompatible, and biodegradable. It is a viscous, readily cold water soluble liquid and transparent. Those features help in the production of the final film not only for the mechanical properties but also for the physical properties of the film. As reported in literature, to obtain a homogeneous blend it is important to add maximally 30% w/w of glycerol.

Another important plasticizer is polyethylene glycol. The chain length of polyethylene glycol (PEG) can vary from 300 g/mol to weights of the 10⁶ order. Literature reports the use as plasticizer of PEGs with molecular weight between 500 and 4000 g/mol. This compound is often used in pharmaceutical applications, especially in the fabrication of stealth coated drug-delivery systems. This implies that the biocompatibility of PEG is proven due to years of toxicological studies. PEG is also used to improve solubility of hydrophobic polymers such as polylactic acid (PLA), in the formation of micelles, emulsions and other pharmaceutical delivery systems. Many attempts of blends between starch and PEGs are reported in literature, not only to increase starch solubility, but also to give mechanical properties such as elasticity and flexibility. It is important to note that none of those blends make the starch soluble, but the resulting films are soluble in the PEG components and easily disrupted in contact with water.

With ethylene glycol monomers, starch has been extensively functionalized to give hydroxypropyl starch, with cold water solubility between 40 and 60%, depending on starch degree of functionalization. The industrial process, as reported for example in U.S. Pat. No. 3,577,407A, foresees the use of strong bases as catalysts, notably NaOH, that cannot be completely removed in the final product, and propylene oxide that is an inflammable gas. Even if the industrial process is well known and exploited nowadays, also in alimentary industrial production, the use of dangerous reagents remains an issue and could be improved.

Other attempts to produce cold-water soluble starches have been performed in fast oral dissolving tablets, such explained in U.S. Pat. No. 9,234,049B2. In this patent a superabsorbent powder is prepared, mixing mannitol and starch granules. Starch used in fast dispersing oral tablets has been known since a long time and has been well exploited. However, those kinds of powders if formulated in films (e.g. through thermo-pressing) do not result in a high cold-water solubility. Hence, although the powder form has the appropriate cold-water soluble characteristics, those are not translated in the final film formulation.

From the above, it follows that there is still an unmet need for a starch-based film that is biodegradable and biocompatible and in the use of reagents and, most importantly, in the industrial process of production.

### SUMMARY OF THE INVENTION

A first objective of the present invention it is to provide a product that has the required features suitable both for industrial production and formulation of films that have the necessary characteristics of thickness, transparency, cold-water solubility, resistance, and flexibility.

A second objective is to produce a film that is homogeneous in its composition, without compatibility issues with the other polymer(s), that is still biodegradable and biocompatible.

The third objective it is that the biocompatibility and biodegradability are still preserved in the final product, i.e. that the starch structure is not changed too much. Moreover, the entire process of production has the aim to be green, avoiding the use of dangerous or toxic reagents and their release in the environment.

The fourth objective it is to maintain the process low cost in terms of economical goods and environmental impact.

Finally, another objective of the present invention is to have a biocompatible final product. Although the final product as such may not be fully (100%) biodegradable, e.g. because of the presence of PEG, the amount of non-biodegradable components is reduced to a minimum and is generally considered to qualify as a biodegradable thermoplastic starch that is almost completely soluble in cold water. In fact, when starch is dissolved in cold water, even if it arrives to the sea water, or enters in the soil, it is still a polymer that can be recognized and eaten by animals and microorganisms naturally present in the environment. This opens the circle of recycling in the best way possible, where used products help the environment and try not to interfere with other biological cycles (e.g. MacNeill et al., 2017, Journal of Experimental Botany, Vol. 68 (16), Pages 4433-4453).

As illustrated in the example section, the present inventors have found that a cold water-soluble film having satisfactory solubility (e.g., of above 65%; preferably of at least 70%) and good mechanical properties (e.g., elongation at break of at least 5%; preferably of at least 10%) can be prepared from a thermoplastic starch which is prepared by a method comprising mixing pulse starch and glycerol, thereby obtaining a mixture of pulse starch and glycerol; placing the mixture of pulse starch and glycerol at room temperature for at least 12 hours, thereby obtaining a swelled starch powder; and mixing the swelled starch powder with a polycarboxylic acid and a polyethylene glycol (PEG) having a molecular mass of about 800 g/mol to about 3000 g/mol without the addition of an aqueous carrier. Furthermore, the cold-water soluble films illustrating the invention had the desired thickness and transparency.

Hence, an aspect of the invention relates to a method for preparing a thermoplastic starch (TPS), the method comprising:
mixing pulse starch and glycerol, thereby obtaining a mixture of pulse starch and glycerol;
placing the mixture of pulse starch and glycerol at room temperature for at least 12 hours, thereby obtaining a swelled starch powder; and
extruding the swelled starch powder with a polycarboxylic acid and a polyethylene glycol (PEG) having a molecular mass of about 800 g/mol to about 3000 g/mol without the addition of an aqueous carrier, thereby obtaining the thermoplastic starch.

The present inventors have realised that no aqueous carrier (e.g., no water) needs to be added to the method for preparing the thermoplastic starch. Without being bound to theory, it is thought that the water available in the starch is sufficient to complete the preparation of the thermoplastic starch.

Hence, a further aspect provides the use of a composition comprising pulse starch, glycerol, a polycarboxylic acid, and a PEG having a molecular mass of about 800 g/mol to about 3000 g/mol, for forming a TPS according to the method as defined herein.

A further aspect relates to a thermoplastic starch (TPS) obtained by the methods as taught herein or by the use as taught herein. The TPS can advantageously be used to prepare a cold water-soluble film with good mechanical properties and solubility even in cold water, thereby allowing the use of the cold water-soluble film in plenty of applications requiring solubility at low temperatures, such as for packaging dishwashing compositions, laundry detergents, toilet-cleaning compositions, fabric softening compositions, bath salt compositions, or food compositions.

Accordingly, further aspects relate to:
a cold water-soluble film prepared from the thermoplastic starch as defined herein.
a method for preparing a film, preferably a cold water-soluble film as defined herein, the method comprising: preparing a thermoplastic starch (TPS) according to the methods as taught herein, according to the use of as taught herein, or providing a TPS as defined herein; and thermo-pressing, casting, or calendering of the thermoplastic starch, thereby obtaining the film.
the use of a cold-water soluble film as defined herein, for packaging an anhydrous composition; preferably wherein the composition is a dishwashing composition, a laundry detergent, a toilet-cleaning composition, a fabric softening composition, a bath salt composition, or a food composition.
a packaged composition for the delivery of a composition into an aqueous medium, the package composition comprising: a container made of the film as defined herein, and an anhydrous composition inside the container; preferably wherein the composition is a dishwashing composition, a laundry detergent, a toilet-cleaning composition, a fabric softening composition, a bath salt composition, or a food composition.

The above and further aspects and preferred embodiments of the invention are described in the following sections and in the appended claims. The subject-matter of appended claims is hereby specifically incorporated in this specification.

### DESCRIPTION OF THE DRAWINGS

FIG. 1: Evaluation of solubility of a film according to an embodiment of the invention (W29) in water at 20° C. (on the left) and 45° C. (on the right).

FIG. 2: Elongation at break (in percentage) and resistance at break (in MPa) of various films according to embodiments of the invention.

### DETAILED DESCRIPTION OF THE INVENTION

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements, or method steps. The terms also encompass “consisting of” and “consisting essentially of”.

The recitation of numerical ranges by endpoints includes all numbers and fractions subsumed within the respective ranges, as well as the recited endpoints.

The term “about” as used herein when referring to a measurable value such as a parameter, an amount, a temporal duration, and the like, is meant to encompass variations of and from the specified value, in particular variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

Whereas the term “one or more”, such as one or more members of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All documents cited in the present specification are hereby incorporated by reference in their entirety.

Unless otherwise specified, all terms used in disclosing the invention, including technical and scientific terms, have the meaning as commonly understood by one of ordinary skill in the art to which this invention belongs. By means of further guidance, term definitions may be included to better appreciate the teaching of the present invention.

As mentioned above, the present inventors have found that a thermoplastic film can be easily prepared from a TPS (e.g. without the addition of other polymers) by using a TPS made by a method wherein swelled starch powder is mixed with a PEG having a molecular mass of about 800 g/mol to about 3000 g/mol; e.g., of about 1500 g/mol to about 2500 g/mol. The TPS film has advantageous characteristics such as satisfactory thickness, transparency, solubility in cold water (e.g., 20° C.), resistance and flexibility. The components of the TPS film are biocompatible, and the method for preparing the film can be considered a green technology.

An aspect of the invention relates to a method for preparing or forming a thermoplastic starch, the method comprising:
mixing pulse starch and glycerol, thereby obtaining a mixture of pulse starch and glycerol;
placing the mixture of pulse starch and glycerol at room temperature for at least 12 hours, thereby obtaining a swelled starch powder; and
extruding the swelled starch powder with the polycarboxylic acid, and a polyethylene glycol (PEG) having a molecular mass of about 800 g/mol to about 3000 g/mol without the addition of an aqueous carrier, thereby obtaining the thermoplastic starch.

The wording of performing a method or a method step “without the addition of an aqueous carrier” refers to performing the method or method step without the need or requirement to add an aqueous carrier to the method or method step.

The phrase “extruding the swelled starch powder with the polycarboxylic acid, and a PEG having a molecular mass of about 800 g/mol to about 3000 g/mol without the addition of an aqueous carrier” refers to extruding the swelled starch powder with the polycarboxylic acid and the PEG having a molecular mass of about 800 g/mol to about 3000 g/mol without the need or requirement to add an aqueous carrier to the extrusion step.

In an embodiment, the step of mixing the pulse starch and the glycerol may be performed without the addition of an aqueous carrier.

In an embodiment, the step of placing the mixture of pulse starch and glycerol at room temperature for at least 12 hours may be performed without the addition of an aqueous carrier.

In an embodiment, the method for preparing a thermoplastic starch may be performed without the addition of an aqueous carrier. Without being bound to theory, it is know that starch can comprise non-added water up to about 10% in weight, and hence the water present in the starch can be sufficient to perform the method. In an embodiment, no additional or no extra or no supplemental aqueous carrier (such as water) is added to the method or method steps.

The terms “aqueous carrier”, “aqueous solution”, or “aqueous medium” generally refer to a solution in which the solvent comprises, consists essentially of, or consists of water. In embodiments, the aqueous carrier comprises at least 1% by volume of water. For example, the aqueous carrier comprises at least 5%, at least 10%, at least 20%, at least 30%, at least 40%, at least 50%, at least 60%, at least 70%, at least 80%, at least 90%, at least 95%, or at least 99% by volume of water. In embodiments, the aqueous carrier consists of water.

In embodiments, the TPS forming composition as taught herein may not comprise an added or additional or extra or supplemental aqueous carrier, such as water.

As used herein, the term “pulse” encompasses all dried seeds of legume. There are in general 11 types of pulses: dry beans, dry broad beans, dry peas, chickpeas, cow peas, pigeon peas, lentils, Bambara beans, vetches, lupins and pulses nes (minor pulses).

The term “legume” refers to a plant in the family Fabaceae (or Leguminosae), or the fruit or seed of such a plant.

Dry beans (Phaseolus spp. including several species in Vigna) are selected from the group consisting of Adzuki Beans, Anasazi Beans, Appaloosa Beans, Baby Lima Beans, Black Calypso Beans, Black Turtle Beans, Dark Red Kidney Beans, Great Northern Beans, Jacob's Cattle Trout Beans, Large Faba Beans, Large Lima Beans, Mung Beans, Pink Beans, Pinto Beans, Romano Beans, Scarlet Runner Beans, Tongue of Fire, White Kidney Beans and White Navy Beans.

Dry peas (Pisum spp.) are selected from garden pea (Pisum sativum var. sativum) and protein pea (Pisum sativum var. arvense). Dry peas are represented by: Black-Eyed Peas, Green Peas, Marrowfat Peas, Pigeon Peas, Yellow Peas and Yellow-Eyed Peas.

Chickpeas or chick peas (Cicer arietinum) are selected from gram or Bengal gram, garbanzo or garbanzo bean (kabuli), or Egyptian pea.

Vicia faba, also known as the Broad bean, fava bean, faba bean, field bean, bell bean, or tic bean, is a species of flowering plant in the pea and bean family Fabaceae native to North Africa southwest and south Asia, and extensively cultivated elsewhere.

Lentils (Lens Culinaris) are selected from Beluga Lentils, Brown Lentils, French Green Lentils, Green Lentils, or Red Lentils.

As used herein, the term “pea” refers to the round seeds contained in the pod of Pisum sativum and its subspecies, varieties or cultivars. Preferably, the peas are yellow peas, preferably dry yellow peas, i.e. yellow peas which have been harvested in a dry state. Different varieties of peas may be for examples smooth pea or wrinkled pea. The term “pea” may also refer to chickpea or Vicia faba. The chickpea or chick pea (Cicer arietinum) is a legume of the family Fabaceae, subfamily Faboideae. Its different types are variously known as gram, or Bengal gram, garbanzo or garbanzo bean, or Egyptian pea. Vicia faba, also known as the broad bean, fava bean, faba bean, field bean, bell bean, or tic bean, is a species of flowering plant in the pea and bean family Fabaceae native to North Africa southwest and south Asia, and extensively cultivated elsewhere.

As used herein, the term “starch” refers to a polymeric carbohydrate encompassing a large number of glucose units joined by glycosidic bonds. As used herein, the starch is in the native form. As used herein, the term “native” refers to starch that has not been modified by enzymatic or chemical processing methods. Native starch may however have been modifying by physical methods such as thermal treatment, extrusion and/or processing. According to the invention, starch may be precooked and pregelatinized.

As used herein the term “pulse starch” encompasses starch extracted from any kind of pulse.

As used herein, the term “pea starch” encompasses starch extracted from peas and in its native form is rich in amylose (up to 35%). According to the invention, pea starch can be isolated using techniques such as pin milling and air classification. Air classification is the most commonly used commercial method for pea starch isolation. The process requires a very high degree of particle size reduction (achieved by pin milling) in order to separate the starch granules from the protein matrix. The major fraction from the air classification process is the low-protein starch fraction, which is separated from the fine protein fraction during the process. The starch concentrate contains about 65% of starch. Residual protein associated with air classified field pea starch granules is derived from protein bodies, agglomerates, chloroplast membrane remnants (which enclose the starch granule) and from a water-soluble fraction which is presumably derived from the dehydrated starch. Re-milling and reclassifying the starch fraction removes most of the protein bodies and agglomerates while water washing results in removal of most of the remainder of the attached protein. The above purification procedure results in a protein content of 0.25% in the washed starch. The purity of starch obtained by wet processing is higher than that obtained by air-classification. Smooth pea starch could be extracted in high yields (93.8-96.7%) from its flour, after protein extraction at pH 9 using different sieving (200-60 pm) and washing conditions. The starches were found to be contaminated mainly by cell wall polysaccharides (less than 4%). The protein content in the starch ranged from 0.3-0.4%. (Starch 54 (2002) 217-234; Pea starch: Composition structure and properties—A review). Nastar® is native pea starch from yellow peas, and commercially available product from Cosucra Warcoing, Belgium. Nastar® comprises minimally 88% dry matter, i.e. native pea starch. Pea starch for use in the present invention can be obtained from Cosucra Warcoing, Belgium.

The two major components of starch are amylose and amylopectin. Generally, legume starches are characterized by a high amylose content (24-65%). But the amylose content of smooth pea, pea mutants and wrinkled pea starches range from 33.1-49.6%, 8-72% and 60.5-88% respectively. Amylose, the minor component, consists mainly of a (1-4) (amylose) linked D-glucopyranosyl residues. The molecular weight of amylose varies between 105-106 Da. Amylopectin is the major component of field pea starch with a Mw of the order 107-109 Da. Amylopectin is composed of linear chains of (1-4) α-D-glucose residues connected through (1-6)-α-linkages (5-6%). The granule size of smooth pea starch is variable and ranges from 2-40 μm. Most of the granules are oval, although spherical, round elliptical and irregularly shaped granules are also found. Pea starch has a low temperature of gelatinisation and syneresis of pea starch after gelation is significant.

In embodiments of the products (including the TPS forming compositions, thermoplastic starch, films, and packaged products), methods, or uses as taught herein, the pulse starch is pea starch, preferably the pulse starch is yellow pea starch, faba bean starch, or chickpea starch.

Typically, the native starch powder used comprises between 8 and 10% water.

Preferably, the starch used is pea starch, obtainable through wet fractionation, that has a purity on dry mass of above or equal to 95%, preferably above or equal to 98% (in contrast to pea starch obtained by dry fractionation which only has a purity of about 65%).

The term “polycarboxylic acid” refers to an organic carboxylic acid whose chemical structure contains at least two carboxyl functional groups (—COOH). In embodiments, the polycarboxylic acid is a dicarboxylic acid, a tricarboxylic acid, or a mixture thereof.

Preferred examples are tartaric acid (containing two carboxyl functional groups) and citric acid (containing three carboxyl functional groups). In embodiments of the products, methods, or uses as taught herein, the polycarboxylic acid is citric acid or tartaric acid; preferably the polycarboxylic acid is citric acid.

The term “polyethylene glycol” or “PEG” refers to a polyether compound comprising polymers of ethylene-oxide derived from petroleum with many applications, from industrial manufacturing to medicine. PEG is a hydrophilic flexible water-soluble polymer. PEGs exist in many different molecular weights, indicated by the number following the PEG designation. For example, “PEG1000” refers to a PEG polymer having an average molecular weight (Mw) of about 1000 Dalton (1 kDa), “PEG2000” to a PEG polymer having an average molecular weight (Mw) of about 2000 Dalton (2 kDa) etc.

In embodiments of the products, methods, or uses as taught herein, the PEG has a molecular mass of about 1000 g/mol to about 2500 g/mol; preferably the PEG has a molecular mass of about 1500 g/mol to about 2500 g/mol; more preferably the PEG has a molecular mass of about 2000 g/mol. In essence, this implies that preferably PEG1000 to PEG2500 is used (respectively having an average molecular weight of about 1000 and 2500 Dalton), and more preferably PEG2000 (PEG having an average molecular weight of about 2000). In embodiments, the PEG has a molecular mass of about 1500 g/mol to about 2500 g/mol, of about 1600 g/mol to about 2400 g/mol, or of about 1800 g/mol to about 2200 g/mol. Such PEG advantageously allows to form a thermoplastic starch which can be used to prepare a TPS film with satisfactory mechanical properties and good solubility even in cold water.

In embodiments, the methods as taught herein may comprise:
mixing pulse starch and glycerol, thereby obtaining a mixture of pulse starch and glycerol;
placing the mixture of pulse starch and glycerol at room temperature for at least 12 hours, thereby obtaining a swelled starch powder;
extruding the swelled starch powder with the polycarboxylic acid and the PEG; and
collecting the thermoplastic starch.

In embodiments, the extrusion of the swelled starch powder with the polycarboxylic acid and the PEG may be performed for about 1 minute to about 15 minutes. In embodiments, the extrusion of the swelled starch powder with the polycarboxylic acid and the PEG may be performed for about 1.5 minutes to about 10 minutes, about 2 minutes to about 8 minutes, about 2.5 minutes to about 6 minutes, or about 3 minutes to about 5 minutes. In embodiments, the extrusion of the swelled starch powder with the polycarboxylic acid and the PEG may be performed for about 1 minute to about 5 minutes; preferably for about 2 minutes to about 4 minutes or for about 2.5 minutes to about 3.5 minutes. Such extrusion timing advantageously results in a film having better mechanical properties such as an increased elongation at break and/or resistance at break.

In embodiments, the extrusion of the swelled starch powder with the polycarboxylic acid and the PEG may be performed at about 105° C. to about 145° C. In embodiments, the extrusion of the swelled starch powder with the polycarboxylic acid and the PEG may be performed at about 105° C. to about 140° C., at about 105° C. to about 135° C., at about 105° C. to about 130° C., at about 105° C. to about 125° C., or at about 105° C. to about 120° C. In embodiments, the extrusion of the swelled starch powder with the polycarboxylic acid and the PEG may be performed at about 105° C. to about 115° C.

In embodiments of the methods or uses as taught herein, the extrusion of the swelled starch powder with the polycarboxylic acid and the PEG may be performed for about 1 minute to about 15 minutes at about 105° C. to about 145° C. In embodiments, the extrusion of the swelled starch powder with the polycarboxylic acid and the PEG may be performed for about 1.5 minutes to about 10 minutes, about 2 minutes to about 8 minutes, about 2.5 minutes to about 6 minutes, or about 3 minutes to about 5 minutes at about 105° C. to about 145° C. In embodiments, the extrusion of the swelled starch powder with the polycarboxylic acid and the PEG may be performed for about 1 minute to about 5 minutes at about 105° C. to about 115° C.; preferably for about 2 minutes to about 4 minutes at about 105° C. to about 145° C.; more preferably for about 2.5 minutes to about 3.5 minutes at about 105° C. to about 145° C. Such extrusion step advantageously results in a film having better mechanical properties such as an increased elongation at break and/or an increased resistance at break.

In embodiments, the extrusion of the swelled starch powder with the polycarboxylic acid and the PEG may be performed for about 2.5 minutes to about 3.5 minutes at about 105° C. to about 145° C. or equal temperature/time ratios. In embodiments, the extrusion of the swelled starch powder with the polycarboxylic acid and the PEG is performed for about 2.5 minutes to about 3.5 minutes at about 105° C. to about 140° C., at about 105° C. to about 135° C., at about 105° C. to about 130° C., at about 105° C. to about 125° C., at about 105° C. to about 120° C., or equal temperature/time ratios. In embodiments, the extrusion of the swelled starch powder with the polycarboxylic acid and the PEG is performed for about 2.5 minutes to about 3.5 minutes at about 105° C. to about 115° C. or equal temperature/time ratios.

In embodiments of the methods or uses as taught herein, prior to the extrusion step, the swelled starch powder may be mixed with a polycarboxylic acid and a polyethylene glycol (PEG) having a molecular mass of about 800 g/mol to about 3000 g/mol without the addition of an aqueous carrier. Such mixing or pre-mixing step allows to mix the compounds homogenously prior to adding them into an extruder.

In embodiments of the methods as taught herein, the mixing of the swelled starch powder with the polycarboxylic acid and the PEG may be performed for about 2.5 minutes to about 3.5 minutes at about 105° C. to about 145° C. In embodiments of the methods as taught herein, the mixing of the swelled starch powder with the polycarboxylic acid and the PEG may be performed for about 2.5 minutes to about 3.5 minutes at about 105° C. to about 140° C., at about 105° C. to about 135° C., at about 105° C. to about 130° C., at about 105° C. to about 125° C., at about 105° C. to about 120° C., or at about 105° C. to about 115° C.

In embodiments of the methods as taught herein, the mixing of the swelled starch powder with the polycarboxylic acid and the PEG may be performed for about 1 minute to about 15 minutes. In embodiments, the mixing of the swelled starch powder with the polycarboxylic acid and the PEG may be performed for about 1.5 minutes to about 10 minutes, about 2 minutes to about 8 minutes, about 2.5 minutes to about 6 minutes, or about 3 minutes to about 5 minutes.

In embodiments, the mixing of the swelled starch powder with the polycarboxylic acid and the PEG may be performed at room temperature, i.e., a temperature between 15° C. and 25° C., e.g., at about 20° C. In embodiments of the methods as taught herein, the mixing of the swelled starch powder with the polycarboxylic acid and the PEG may be performed at room temperature for about 1 minute to about 15 minutes. In embodiments, the mixing of the swelled starch powder with the polycarboxylic acid and the PEG may be performed at room temperature for about 1.5 minutes to about 10 minutes, about 2 minutes to about 8 minutes, about 2.5 minutes to about 6 minutes, or about 3 minutes to about 5 minutes. For instance, the mixing step may be performed in a mixing chamber of the extruder in order to mix the compounds homogenously prior to extrusion.

An aspect of the present invention hence provides for a composition for forming a thermoplastic starch (“TPS forming composition”, briefly referred to herein as “composition”), the composition comprising pulse starch, glycerol, a polycarboxylic acid, and a polyethylene glycol (PEG) having a molecular mass of about 800 g/mol to about 3000 g/mol. In essence, this implies that PEG800 to PEG3000 is used (respectively having an average molecular weight of about 800 and 3000 Dalton).

An aspect provides the use of the composition as taught herein for forming a thermoplastic starch (TPS); preferably according to the methods as taught herein. Hence, an aspect provides the use of a composition comprising pulse starch, glycerol, a polycarboxylic acid, and a polyethylene glycol (PEG) having a molecular mass of about 800 g/mol to about 3000 g/mol, for forming a thermoplastic starch (TPS), preferably for forming a TPS according to the methods as defined herein.

In embodiments of the products, methods, or uses as taught herein, the following amounts of components may be used, or the TPS forming composition may comprise, consist essentially of, or consist of:
from about 60% to about 95% by weight of pulse starch;
from about 2% to about 30% by weight of glycerol;
from about 1.0% to about 3.0% by weight of the polycarboxylic acid; and/or
from about 1.0% to about 3.0% by weight of the PEG.

In embodiments of the products, methods, or uses as taught herein, the TPS forming composition comprises from about 60% to about 95% by weight, from about 65% to about 90% by weight, from about 70% to about 85% by weight, from about 70% to about 80% by weight, or from about 75% to about 80% by weight of pulse starch.

Preferably, said TPS forming composition comprises, consists essentially of, or consists of:
from about 65% to about 90% by weight of pulse starch;
from about 10% to about 25% by weight of glycerol;
from about 1.5% to about 3.0% by weight of the polycarboxylic acid; and/or
from about 1.5% to about 3.0% by weight of the PEG.

Preferably, said TPS forming composition comprises, consists essentially of, or consists of:
from about 70% to about 80% by weight of pulse starch;
from about 10% to about 25% by weight of glycerol;
from about 1.5% to about 3.0% by weight of the polycarboxylic acid; and/or
from about 1.5% to about 3.0% by weight of the PEG.

In embodiments of the products, methods, or uses as taught herein, the TPS forming composition may further comprise a natural gum; preferably a natural gum selected from the group consisting of: sodium alginate, gellan gum, xanthan gum, agar, alginic acid, carrageenan, gum arabic, gum ghatti, gum tragacanth, karaya gum, guar gum, locust bean gum, beta-glucan, dammar gum, glucomannan, psyllium seed husks, and tara gum. In some embodiments, the natural gum can be a natural gum obtained from seaweeds, a natural gum produced by bacterial fermentation, or a natural gum obtained from non-marine botanical resources.

A further aspect provides a thermoplastic starch (TPS) obtained from the composition as taught herein.

A further aspect provides a TPS obtainable or obtained by the methods as taught herein or by the use as taught herein.

A related aspect or embodiment provides a TPS or TPS forming composition comprising (including consisting essentially of or consisting of) pulse starch, glycerol, a polycarboxylic acid, and a PEG having a molecular mass of about 800 g/mol to about 3000 g/mol. In embodiments, the TPS or TPS forming composition comprises pulse starch, glycerol, citric acid, and a PEG having a molecular mass of about 800 g/mol to about 3000 g/mol. In embodiments, the TPS or TPS forming composition comprises pulse starch, glycerol, tartaric acid, and a PEG having a molecular mass of about 800 g/mol to about 3000 g/mol.

In embodiments, the TPS or TPS forming composition comprises (including consists essentially of or consists of) pea starch, glycerol, a polycarboxylic acid, and a PEG having a molecular mass of about 800 g/mol to about 3000 g/mol. In embodiments, the TPS or TPS forming composition comprises pea starch, glycerol, citric acid, and a PEG having a molecular mass of about 800 g/mol to about 3000 g/mol. In embodiments, the TPS or TPS forming composition comprises pea starch, glycerol, tartaric acid, and a PEG having a molecular mass of about 800 g/mol to about 3000 g/mol.

In embodiments, the TPS or TPS forming composition may comprise (including may consist essentially of or may consist of) pulse starch, glycerol, a polycarboxylic acid, and a PEG having a molecular mass of about 1000 g/mol to about 2500 g/mol or of about 1500 g/mol to about 2500 g/mol. In embodiments, the TPS or TPS forming composition comprises pulse starch, glycerol, citric acid, and a PEG having a molecular mass of about 1000 g/mol to about 2500 g/mol or of about 1500 g/mol to about 2500 g/mol. In embodiments, the TPS or TPS forming composition comprises pulse starch, glycerol, tartaric acid, and a PEG having a molecular mass of about 1000 g/mol to about 2500 g/mol or of about 1500 g/mol to about 2500 g/mol.

In embodiments, the TPS or TPS forming composition comprises (including consists essentially of or consists of) pea starch, glycerol, a polycarboxylic acid, and a PEG having a molecular mass of about 1000 g/mol to about 2500 g/mol or of about 1500 g/mol to about 2500 g/mol. In embodiments, the TPS or TPS forming composition comprises pea starch, glycerol, citric acid, and a PEG having a molecular mass of about 1000 g/mol to about 2500 g/mol or of about 1500 g/mol to about 2500 g/mol. In embodiments, the TPS or TPS forming composition comprises pea starch, glycerol, tartaric acid, and a PEG having a molecular mass of about 1000 g/mol to about 2500 g/mol or of about 1500 g/mol to about 2500 g/mol.

Such TPS forming compositions or TPS satisfactorily allow to prepare a cold water-soluble film having good solubility and mechanical properties, and having the thickness and transparency required for their applications.

A further aspect relates to a cold water-soluble film prepared from the thermoplastic starch as defined herein. In embodiments, the comprises (including consists essentially of or consists of) pulse starch, glycerol, a polycarboxylic acid (e.g. citric acid or tartaric acid), and a PEG having a molecular mass of about 800 g/mol to about 3000 g/mol (and no aqueous carrier). Preferably, the pulse starch is pea starch, more preferably yellow pea starch, faba bean starch, or chickpea starch. Without wanting to be bound to any theory it is believed that the different components are (fully or partially) linked as esters/ethers and/or through hydrogen bonds to the pulse starch.

The terms “film”, “thermoplastic film”, “thermoplastic starch film”, or “TPS film” may be used interchangeably herein.

The phrases “cold-water soluble” or “soluble in an aqueous medium at room temperature” may be used interchangeably herein.

The term “cold water” as used herein refers to any aqueous medium at room temperature (and is not limited to but preferably water at room temperature).

The term “room temperature” refers to a temperature between 15° C. and 25° C., e.g., at about 20° C.

Hence, in embodiments, the film may be soluble in an aqueous medium at room temperature, such as in an aqueous medium at a temperature between 15° C. and 25° C., e.g., at about 20° C. For instance, the film may be soluble in an aqueous medium at a temperature between 18° C. and 22° C.

In embodiments of the film as taught herein, the film has a solubility in an aqueous medium at room temperature (i.e., between 15 and 25° C., e.g. at 20° C.) of above 65%, such as of at least 70%, of at least 75%; preferably of at least 80% or more, such as of at least 85%, or at least 90%, or at least 99%, or 100%. Such films have sufficient solubility in cold water (e.g., in water at a temperature between 15 and 25° C., e.g. at 20° C.), as desired or required for certain applications as taught herein.

The solubility of the film may be determined by methods as known in the art. For instance, the solubility of the film may be determined by dissolving a predetermined amount (e.g., 1 gram) of the film in an amount (e.g., 20 ml) of water such as distilled water; mixing the solution for instance with a vortex (e.g., for 2 min); centrifuging the solution (e.g., at 4000 rpm for 10 minutes); lyophilizing the upper solution; and drying the obtained precipitate for instance in a vacuum oven (e.g., at 60° C. for at least 5 h). The solubility (in percentage) may then be calculated as the ratio of the weight the dried obtained precipitate to the weight of the film at start, times 100. For instance, in case the weight of the dried obtained precipitate is 0.76 g and the weight of the film at start is 1.00 g, the solubility (in percentage) is 76%, i.e. 100×0.76/1.00.

In embodiments of the film as taught herein, the film has an elongation at break of at least 5% such as at least 10%. In embodiments, the film has an elongation at break of at least 11%, at least 12%, at least 13%, at least 14% or at least 15%. Such films have satisfactory mechanical properties.

The elongation at break (in percentage) can be measured for example by using a Traction machine from Zwick Roell Z2.5, with a Load Cell Type XForce P Nominal Force 2500N. DogBones specifics: about 9 mm width in the extremities and about 3 mm width in the central segment. Preferably, the elongation at break of the film is measured after conditioning of the film in a controlled atmosphere between 40% and 70% relative humidity for between 5 h and 24 h. For instance, the elongation at break of the film is measured after conditioning of the film in a controlled atmosphere between 40% and 70% relative humidity for between 10 h and 16 h. More preferably, the elongation at break of the film is measured after conditioning of the film in a controlled atmosphere at 60% relative humidity for 12 h.

In embodiments of the film as taught herein, the film has an elongation at break of at least 5% such as at least 10% after conditioning of the film in a controlled atmosphere between 40% and 70% relative humidity for between 5 h and 24 h, e.g., after conditioning of the film in a controlled atmosphere at 60% relative humidity for 12 h. In embodiments, the film has an elongation at break of at least 11%, at least 12%, at least 13%, at least 14% or at least 15% after conditioning of the film in a controlled atmosphere between 40% and 70% relative humidity for between 5 h and 24 h, e.g., after conditioning of the film in a controlled atmosphere at 60% relative humidity for 12 h. Such films have satisfactory elongation at break properties.

In embodiments of the film as taught herein, the film has a resistance at break of at least 2 MPa, such as at least 3 MPa, at least 4 MPa, at least 5 MPa, at least 6 MPa, at least 8 MPa, or at least 10 MPa. In embodiments, the film has a resistance at break of at least 12 MPa, such as at least 14 MPa, or at least 16 MPa. In embodiments, the film has a resistance at break of from 2 MPa to 20 MPa, such as from 3 MPa to 10 MPa. Such films have satisfactory mechanical properties.

The resistance (in Mpa) can be measured for example by using a Traction machine from Zwick Roell Z2.5, with a Load Cell Type XForce P Nominal Force 2500N. DogBones specifics: about 9 mm width in the extremities and about 3 mm width in the central segment. Preferably, the resistance at break of the film is measured after conditioning of the film in a controlled atmosphere between 40% and 70% relative humidity for between 5 h and 24 h. For instance, the resistance at break of the film is measured after conditioning of the film in a controlled atmosphere between 40% and 70% relative humidity for between 10 h and 16 h. More preferably, the resistance at break of the film is measured after conditioning of the film in a controlled atmosphere at 60% relative humidity for 12 h.

In embodiments of the film as taught herein, the film has a resistance at break of at least 2 MPa, such as at least 3 MPa, at least 4 MPa, at least 5 MPa, at least 6 MPa, at least 8 MPa, or at least 10 MPa after conditioning of the film in a controlled atmosphere between 40% and 70% relative humidity for between 5 h and 24 h, e.g., after conditioning of the film in a controlled atmosphere at 60% relative humidity for 12 h. In embodiments, the film has a resistance at break of at least 12 MPa, such as at least 14 MPa, or at least 16 MPa. In embodiments, the film has a resistance at break of from 2 MPa to 20 MPa, such as from 3 MPa to 10 MPa after conditioning of the film in a controlled atmosphere between 40% and 70% relative humidity for between 5 h and 24 h, e.g., after conditioning of the film in a controlled atmosphere at 60% relative humidity for 12 h. Such films have satisfactory resistance at break.

In embodiments of the film as taught herein, the film has an elongation at break of at least 5% and a resistance at break of at least 2 MPa, such as at least 3 MPa, at least 4 MPa, at least 5 MPa, at least 6 MPa, at least 8 MPa, or at least 10 MPa. In embodiments of the film as taught herein, the film has an elongation at break of at least 10% and a resistance at break of at least 2 MPa, such as at least 3 MPa, at least 4 MPa, at least 5 MPa, at least 6 MPa, at least 8 MPa, or at least 10 MPa. Such films have satisfactory mechanical properties.

In embodiments of the film as taught herein, the film has a solubility in an aqueous medium at room temperature (between 15 and 25° C., e.g. at 20° C.) of above 65%, of at least 70%, at least 75%, or at least 80%, an elongation at break of at least 5%, and a resistance at break of at least 2 MPa, such as at least 3 MPa, at least 4 MPa, or at least 5 MPa. In embodiments of the film as taught herein, the film has a solubility in an aqueous medium at room temperature (between 15 and 25° C., e.g. at 20° C.) of at least 70%, an elongation at break of at least 10%, and a resistance at break of at least 2 MPa, such as at least 3 MPa, at least 4 MPa, or at least 5 MPa. Preferably, the films as taught herein have a solubility in an aqueous medium at room temperature (between 15 and 25° C., e.g. at 20° C.) of at least 80%, an elongation at break of at least 10%, and a resistance at break of at least 5 MPa. Such films have satisfactory solubility and mechanical properties including both resistance and flexibility.

In embodiments of the film as taught herein, the film has a thickness of 15 μm to 200 μm; preferably the film has a thickness of 30 μm to 150 μm, more preferably the film has a thickness of from 30 μm to 100 μm, such as from 30 μm to 75 μm or from 75 μm to 100 μm. In embodiments of the film as taught herein, the film is transparent and/or flexible.

A further aspect provides a method for preparing a film, such as a cold water-soluble film, preferably a film as defined herein, the method comprising:
preparing a thermoplastic starch (TPS) according to the methods as taught herein, according to the use as defined herein, or providing a TPS as defined herein; and
thermo-pressing, casting, or calendering of the thermoplastic starch, thereby obtaining the film.

Hence, an aspect provides a method for preparing a thermoplastic starch film, such as a cold water-soluble thermoplastic starch film, the method comprising:
mixing pulse starch and glycerol, thereby obtaining a mixture of pulse starch and glycerol;
placing the mixture of pulse starch and glycerol at room temperature for at least 12 hours, thereby obtaining a swelled starch powder;
extruding the swelled starch powder with a polycarboxylic acid and a polyethylene glycol (PEG) having a molecular mass of about 800 g/mol to about 3000 g/mol without the addition of an aqueous carrier, thereby obtaining a thermoplastic starch; and
thermo-pressing, casting, or calendering of the thermoplastic starch, thereby obtaining the thermoplastic starch film. Such thermoplastic starch film advantageously is a cold water soluble film suitable for packaging an anhydrous composition such as a dishwashing composition, a laundry detergent, a toilet-cleaning composition, a fabric softening composition, a bath salt composition, or a food composition.

The term “extruding” encompasses any process of forming sheet-like films of biopolymer. In essence the extruding process encompasses a high-volume manufacturing process in which raw thermoplastic pellets are heated (melted) and formed into a continuous profile. Extrusion produces items such as films and sheeting, and thermoplastic coatings. This process starts by feeding the bioplastic material (pellets, granules, flakes or powders) into the extruder. The material is gradually heated (melted) by the mechanical energy generated by turning screws and if needed by heaters arranged along the extruder. The molten biopolymer is then forced into a die, which shapes the polymer into a shape that hardens during cooling.

The term “thermo-pressing” or “thermal pressing” or “hot pressing” encompasses any technology wherein a biopolymer film is sandwiched between two (heated) plates, thereby forming a reduced film of the required thickness.

Alternatively to thermo-pressing, the biopolymer can be cast into a sheet form for a wide variety of ongoing uses. In the film casting process, the process comprises evaporation (under vacuum or not) of the solvent in which the material is readily soluble and then the molten polymer is usually extruded through a slot die onto an internally cooled chill roll and then passes through a series of rollers which will determine the nature and properties of the cast film including thickness. The cast film is then cut as required by saws, shears or hot wire methods.

As a further alternative, the biopolymer can be made into a film through calendering. Calendering is the process of forming a continuous sheet of controlled size by squeezing a softened thermoplastic material between two or more horizontal rolls. The biopolymer (e.g. in powder or pellets) is first fluxed, i.e., heated and worked until it reaches a molten or dough-like consistency, and discharged to a calender (e.g. comprising calender rollers) either in a continuous strip or in batches. When an extruder is used for fluxing, the extrudate is fed directly to the calender. Alternatively, the biopolymer can in some cases be fed directly to the calender. After passage through the calender, the continuous sheet of hot plastic is stripped off the last calender roll with a small, higher-speed stripping roll. The hot sheet is cooled as it travels over a series of cooling drums. The film or sheeting is finally cut into individual sheets or wound up in a continuous roll.

In embodiments of the methods as taught herein, the thermo-pressing may be performed for about 8 minutes to about 12 minutes at about 115° C. to about 125° C. and about 10 bar to about 12 bar.

In embodiments of the methods as taught herein, the thermo-pressing may comprise the prior steps of contacting the extruded starch with the thermo-pressing system; and/or alternating pressing and depressing the extruded starch.

A further aspect provides the use of a cold-water soluble film as defined herein or a cold water soluble film obtained by the methods as defined herein, for packaging a composition, preferably an anhydrous composition. In embodiments, the composition may be a dishwashing composition, a laundry detergent, a toilet-cleaning composition, a fabric softening composition, a bath salt composition, or a food composition. In some embodiments, the composition can be in granular form, or the composition can be in liquid form.

A further aspect relates to a packaged composition for the delivery of a composition, such as an anhydrous composition, into an aqueous medium, the package composition comprising:
a container made of the film as defined herein, and
a composition inside the container; preferably wherein the composition is a dishwashing composition, a laundry detergent, a toilet-cleaning composition, a fabric softening composition, a bath salt composition, or a food composition.

In embodiments, the film may be a film obtained by the methods as defined herein.

A further aspect relates to a method of delivering a composition, such as an anhydrous composition, to an aqueous medium, the method comprising contacting the packaged composition as defined herein with the aqueous medium; preferably immersing the packaged composition as defined herein in the aqueous medium.

The present application also provides aspects and embodiments as set forth in the following Statements:
Statement 1. A method for preparing a thermoplastic starch, the method comprising:
   mixing pulse starch and glycerol, thereby obtaining a mixture of pulse starch and glycerol;
   placing the mixture of pulse starch and glycerol at room temperature for at least 12 hours, thereby obtaining a swelled starch powder; and
   extruding the swelled starch powder with a polycarboxylic acid and a polyethylene glycol (PEG) having a molecular mass of about 800 g/mol to about 3000 g/mol without the addition of an aqueous carrier, thereby obtaining the thermoplastic starch.
Statement 2. The method according to statement 1, wherein the extrusion of the swelled starch powder with the polycarboxylic acid and the PEG is performed for about 1 minute to about 15 minutes at about 105° C. to about 145° C. or equal temperature/time ratios.
Statement 3. The method according to claim 1 or 2, wherein prior to the extrusion step, the swelled starch powder is mixed with a polycarboxylic acid and a polyethylene glycol (PEG) having a molecular mass of about 800 g/mol to about 3000 g/mol without the addition of an aqueous carrier.
Statement 4. The method according to any one of statements 1 to 3, wherein the polycarboxylic acid is citric acid or tartaric acid; preferably wherein the polycarboxylic acid is citric acid.
Statement 5. The method according to any one of statements 1 to 4, wherein the PEG has a molecular mass of about 1000 g/mol to about 2500 g/mol; preferably wherein the PEG has a molecular mass of about 1500 g/mol to about 2500 g/mol.
Statement 6. The method according to any one of statements 1 to 5, wherein the following amounts of components are used:
   from about 60% to about 95% by weight of pulse starch;
   from about 2% to about 30% by weight of glycerol;
   from about 1.0% to about 3.0% by weight of the polycarboxylic acid; and/or
   from about 1.0% to about 3.0% by weight of the PEG.
Statement 7. The method according to any one of statements 1 to 6, wherein the pulse starch is pea starch; preferably wherein the pulse starch is yellow pea starch, faba bean starch, or chickpea starch.
Statement 8. Use of a composition comprising pulse starch, glycerol, a polycarboxylic acid, and a polyethylene glycol (PEG) having a molecular mass of about 800 g/mol to about 3000 g/mol, for forming a thermoplastic starch (TPS) according to the method as defined in any one of statements 1 to 7.
Statement 9. A thermoplastic starch (TPS) obtained by the method according to any one of statements 1 to 7 or by the use according to statement 8.
Statement 10. The TPS according to statement 9, comprising pulse starch, glycerol, a polycarboxylic acid, and a polyethylene glycol (PEG) having a molecular mass of about 800 g/mol to about 3000 g/mol.
Statement 11. A cold water-soluble film prepared from the thermoplastic starch as defined in statement 9 or 10.
Statement 12. The cold water-soluble film according to statement 11, wherein the film is transparent and/or flexible; and/or wherein the film has a thickness of 15 μm to 200 μm; preferably wherein the film has a thickness of 20 μm to 120 μm.
Statement 13. A method for preparing a film, preferably a cold water-soluble film as defined in statement 11 or 12, the method comprising:
   preparing a thermoplastic starch (TPS) according to the method of any one of statements 1 to 7, according to the use of statement 8, or providing a TPS as defined in statement 9 or 10; and
   thermo-pressing, casting, or calendering of the thermoplastic starch, thereby obtaining the film.
Statement 14. Use of a cold-water soluble film as defined in statement 11 or 12, for packaging an anhydrous composition; preferably wherein the composition is a dishwashing composition, a laundry detergent, a toilet-cleaning composition, a fabric softening composition, a bath salt composition, or a food composition.
Statement 15. A packaged composition for the delivery of a composition into an aqueous medium, the package composition comprising:
   a container made of the film as defined in statement 11 or 12, and
   an anhydrous composition inside the container; preferably wherein the composition is a dishwashing composition, a laundry detergent, a toilet-cleaning composition, a fabric softening composition, a bath salt composition, or a food composition.

The above aspects and embodiments are further supported by the following non-limiting examples.

### EXAMPLES

### Materials and Methods

### 1. Materials

The pea starch used in the study has been provided by COSUCRA, Warcoing, Belgium. Glycerol used as plasticizer in this study has been purchased from Alfa Aesar. Polyethylene glycol (PEG) and citric acid monohydrate used as solubilizing additives have been purchased from Sigma Aldrich. Tartaric acid used as dispersing agent has been purchased from Supelco. Sodium Alginate purchased by PanReac AppliChem has been used as reinforcing agents.

### 2. Film Preparation

2.1. Starch Swelling with Plasticizer

Pea starch (32 g) and glycerol (8 g) were manually mixed in a plastic bag for 5 minutes. After this time the mixture was left to swell for 24 h.

### 2.2. Starch Blend

In a glass beaker the following components were exactly weighted and hand-mixed: PEG 2000 g/mol (1 g) and citric acid monohydrate (1 g). The mixture of swelled starch and glycerol (step 2.1) and the mixture of PEG (2000 g/mol) and citric acid monohydrate were hand-mixed at room temperature and then inserted in the extruder (step 2.3).

### 2.3. Melt-Blending of TPS Inside a Twin-Screw DSM Micro-Compounder, 15 cc

A DSM micro-compounder was heated at 115° C. The mixture of swelled starch, glycerol, PEG (2000 g/mol), and citric acid was inserted in the shortest time possible (usually 2 minutes) in the extrusion chamber with screws co-rotating at 30 rpm speed. After the total insertion of the raw material, screw speed was increased at 100 rpm and the extrusion lasted for 3 minutes. Then the extrusion room was opened, and the polymer was collected (about 75%, because the process is semi-continuous).

The filament of extruded starch was left to cool down at room temperature and pelletized.

### 2.4. Thermo-Pressing of Extruded Starch

About 2 g of so-prepared extruded starch (step 2.3) was pressed at 120° C., 11 bar for 10 minutes. The thermo-pressing process lasted for 10 minutes at 120° C., 11 bar. After this time, the polymer was cooled down till 20° C., always at 11 bar pression (time to cool down: 4 minutes).

### 3. Solubility Test

Solubility of the samples has been performed dissolving 1 g of the starch based cold water soluble film obtained above in 20 ml of distilled water. The solution has been mixed for 2 minutes with a vortex, and then centrifuged at 4000 rpm for 10 minutes. Subsequently, the upper solution was lyophilized, and the obtained precipitate dried in a vacuum oven at 60° C. for at least 5 h. Then the percentage solubility was calculated based on the weight of the obtained dried precipitate versus the weight of the film started with (1 g).

### Example 1: Preparation of Thermoplastic Starch Films According to Embodiments of the Invention

### Thermoplastic Starch

A mixture of starch (76% by weight compared to total weight of the TPS composition) and glycerol (19% by weight compared to total weight of the TPS composition) was prepared and left to swell as described above. A mixture of PEG (2000 g/mol, 2.5% by weight compared to total weight of the TPS composition) and citric acid monohydrate (2.5% by weight compared to total weight of the TPS composition) was prepared by mixing the components by hand in a glass beaker. Both mixtures were hand-mixed and inserted in the DSM extruder.

### Extrusion

A DSM micro-compounder Explore® of 15 cc was used to extrude the TPS. The mixture of swelled starch, glycerol, PEG (2000 g/mol), and citric acid was inserted in the extruder machine and warmed up at 115° C. The mixture was extruded for 3 minutes at 115° C. and then the extruded starch was collected in the shape of flexible, transparent filaments. The thermoplastic starch was allowed to cool down to room temperature and then it was pelleted in squares of about 0.5 cm. The resulting TPS is referred to herein as “W29” (Table 1). In addition to W29, other thermoplastic starches and films were prepared as described herein, unless indicated otherwise in Table 1.

### Thermo-Pressing

The pellets obtained in 1.3 were pressed at 11 bar for 10 minutes at a temperature of 120° C. The obtained film was allowed to cool down under pressure until a temperature of about 20° C. was reached after which the thermoplastic film was collected.

TABLE 1
Composition and solubility of different TPS films
according to embodiments of the present invention

| | TPS film* | | | | | |
|---|---|---|---|---|---|---|
| | | Tartaric | Tartaric | | Alginate | Alginate |
| | W29 | 3 | 6 | PEG1000 | premixed | 3 |
| Pea starch (% w/w) | 76 | 76 | 76 | 76 | 75 | 75 |
| Glycerol (% w/w) | 19 | 19 | 19 | 19 | 18.5 | 18.5 |
| PEG2000 (% w/w) | 2.5 | 2.5 | 2.5 | — | 2.3 | 2.3 |
| PEG1000 (% w/w) | — | — | — | 2.5 | — | — |
| Citric acid (% w/w) | 2.5 | — | — | 2.5 | 2.3 | 2.3 |
| Tartaric acid (% w/w) | — | 2.5 | 2.5 | — | — | — |
| Alginate (% w/w) | — | — | — | — | 2.4 | 2.4 |
| Solubility (%) | 81 | 73 | 75 | 66 | 41 | 75 |
| Thickness (μm) | 70 | 70 | 70 | 70 | 70 | 70 |

*Tartaric 3: Tartaric acid extruded for 3 min; Tartaric 6: Tartaric acid extruded for 6 min; Alginate premixed: alginate added at the same time as mixture of citric acid and PEG before extrusion; Alginate 3: alginate only added after 3 minutes of extrusion, then extrusion for 1 more minute (4 min in total) with the same parameters: 110 rpm at 115° C.

### Example 2: Solubility of Thermoplastic Films According to Embodiments of the Invention

The solubility of the thermoplastic films illustrating the invention (W29, Tartaric 3, Tartaric 6, and PEG1000) was tested as described above (solubility test). The thickness of the films was also measured. The results are provided in Table 1.

The solubility values listed in Table 1 show the highest solubility for thermoplastic film W29, i.e., when combining PEG2000 and citric acid as solubilizing agents.

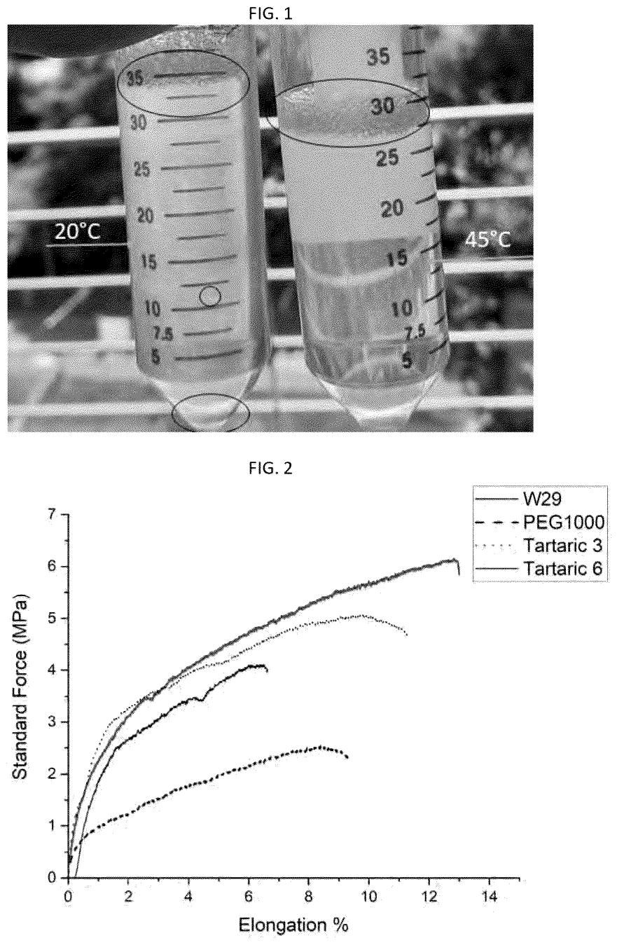

As can be seen in FIG. 1, W29 was readily disrupted in small particles at 20° C. (FIG. 1 on the left, shown for instance in the small circle). The particles precipitated (circle at the bottom of the vial) to give a clear solution after all the particles were precipitated. W29 totally dissolved in water at 45° C. (FIG. 1 on the right) without leaving any residue and/or precipitate. The resulting solution was clear and transparent. In both vials, some foam was present on the top, which points to the surfactant character of the mix (FIG. 1, top).

### Example 3: Tensile Properties and Elasticity of Thermoplastic Films According to Embodiments of the Invention

The thermoplastic films illustrating the invention (W29, Tartaric 3, Tartaric 6, and PEG1000) were cut in dog-bone shape and tensile tests were performed on the so obtained samples. Elongation at break was measured with a cellule of 2500N, until the sample was totally broken (cf. FIG. 2). The elongation at break of the films was measured after conditioning of the films in a controlled atmosphere at 60% relative humidity for 12 h.

FIG. 2 shows the elongation at break in percentage and the resistance at break in MPa of various thermoplastic films. W29 represents the TPS film showing the best combination between desired mechanical properties and solubility in cold water (Table 1 and FIG. 2). Indeed, the thermoplastic film W29 illustrating the invention had a solubility of 81%, an elongation at break of about 13%, and a resistance at break of about 6 MPa. Then, Tartaric 3 and Tartaric 6 represent TPS films that have good mechanical properties and satisfactory solubility. Finally, PEG1000 represents a good candidate for solubility (i.e., solubility of 66%), but the mechanical properties were the less appealing of the tested TPS films (Table 1 and FIG. 2).

What is claimed is:

1. A method for preparing a thermoplastic starch, the method comprising:
mixing pulse starch and glycerol, thereby obtaining a mixture of pulse starch and glycerol;
placing the mixture of pulse starch and glycerol at room temperature for at least 12 hours, thereby obtaining a swelled starch powder; and
extruding the swelled starch powder with a polycarboxylic acid and a polyethylene glycol (PEG) having a molecular mass of about 800 g/mol to about 3000 g/mol without the addition of an aqueous carrier, thereby obtaining the thermoplastic starch.

2. The method according to claim 1, wherein the extrusion is performed for about 1 minute to about 15 minutes at about 105° C. to about 145° C.

3. The method according to claim 1, wherein prior to the extruding, the swelled starch powder is mixed with a polycarboxylic acid and a polyethylene glycol (PEG) having a molecular mass of about 800 g/mol to about 3000 g/mol without the addition of an aqueous carrier.

4. The method according to claim 1, wherein the polycarboxylic acid is citric acid or tartaric acid.

5. The method according to claim 1, wherein the PEG has a molecular mass of about 1000 g/mol to about 2500 g/mol.

6. The method according to claim 1, wherein the following amounts of components are used:
from about 60% to about 95% by weight of the pulse starch;
from about 2% to about 30% by weight of glycerol;
from about 1.0% to about 3.0% by weight of the polycarboxylic acid; and/or
from about 1.0% to about 3.0% by weight of the PEG.

7. The method according to claim 1, wherein the pulse starch is pea starch.

8. (canceled)

9. A thermoplastic starch (TPS) obtained by the method according to claim 1.

10. The TPS according to claim 9, comprising pulse starch, glycerol, a polycarboxylic acid, and a polyethylene glycol (PEG) having a molecular mass of about 800 g/mol to about 3000 g/mol.

11. A cold water-soluble film prepared from the thermoplastic starch according to claim 9.

12. The cold water-soluble film according to claim 11, wherein the film is transparent and/or flexible; and/or wherein the film has a thickness of 15 μm to 200 μm.

13. A method for preparing a film, the method comprising:
preparing a thermoplastic starch (TPS) according to the method of claim 1; and
thermo-pressing, casting, or calendering the thermoplastic starch, thereby obtaining the film.

14. (canceled)

15. A packaged composition for the delivery of a composition into an aqueous medium, the packaged composition comprising:
a container made of the film according to claim 11; and
an anhydrous composition inside the container.

16. The packaged composition according to claim 15, wherein the anhydrous composition is selected from the group consisting of a dishwashing composition, a laundry detergent, a toilet cleaning composition, a fabric softening composition, a bath salt composition and a food composition.

17. The method according to claim 4, wherein the polycarboxylic acid is citric acid

18. The method according to claim 5, wherein the PEG has a molecular mass of about 1500 g/mol to about 2500 g/mol.

19. The method according to claim 7, wherein the pulse starch is yellow pea starch, faba bean starch, or chickpea starch.

20. The method according to claim 12, wherein the film has a thickness of 20 μm to 120 μm.
